(19) United States
(12) Patent Application Publication
(10) Pub. No.: US 2016/0257365 A1
(43) Pub. Date: Sep. 8, 2016

(54) FENDER-MOUNTED BICYCLE SAFETY LIGHT

(71) Applicant: Cho-Ten Chiu, New Taipei (TW)

(72) Inventor: Cho-Ten Chiu, New Taipei (TW)

(21) Appl. No.: 14/641,118

(22) Filed: Mar. 6, 2015

(51) Int. Cl. B62J 6/00; B62J 6/16; F21V 31/00

(52) U.S. Cl. CPC B62J 6/001; F21V 31/00; B62J 6/16; F21Y 2101/02

(57) ABSTRACT

A fender-mounted bicycle safety light is disclosed. The safety light includes a lower cover, having a bottom, a surrounding wall, two positioning posts on the bottom. A top of the surrounding wall is formed with a first step. A positioning protrusion and a threaded rod outward extend from the bottom. An upper cover is assembled with the lower cover and has a surrounding edge, a hole, and a diffuser board secured in the hole. A top of the surrounding edge is formed with a second step corresponding to the first step. A sealing ring is pressed between the first step and the second step. A circuit board being is fastened to the lower cover and has LEDs, a switch and two positioning holes. The two positioning holes are separately passed by the two positioning posts.

### BACKGROUND OF THE INVENTION

1. Technical Field

The invention relates to bicycle lights, particularly to safety lights.

2. Related Art

FIGS. 1-3 depict a typically conventional fender-mounted safety light. The safety light is primarily composed of a tube 5, a sleeve mount 6 and a tail mount 7, all of which are fastened on a fender 3 of a bicycle. An LED lighting bar 8 is disposed in the tube 5, and the tube 5 is fixed by the sleeve mount 6 and the tail mount 7. The sleeve mount 6 and the tail mount 7 are provided with a first fixing hole 61 and two second fixing holes 700 for being fastened by screws 62, 703.

Such a safety light is complicated to assemble because the tube 5, sleeve mount 6 and tail mount 7 must be assembled one by one. It cannot be completed in a single step. Furthermore, the structure of the safety light is not provided with a waterproof mechanism. It is easy to cause damage because of interpenetration of water.

### SUMMARY OF THE INVENTION

An object of the invention is to provide a bicycle safety light, which can be efficiently and easily assembled. Thus the manufacturing cost can be reduced.

Another object of the invention is to provide a bicycle safety light, which has a waterproof function.

Still another object of the invention is to provide a bicycle safety light, which can be easily and matchingly mounted on a fender.

To accomplish the above objects, the safety light of the invention includes a lower cover, having a bottom, a surrounding wall, two positioning posts on the bottom. A top of the surrounding wall is formed with a first step. A positioning protrusion and a threaded rod outward extend from the bottom. An upper cover is assembled with the lower cover and has a surrounding edge, a hole, and a diffuser board secured in the hole. A top of the surrounding edge is formed with a second step corresponding to the first step. A sealing ring is pressed between the first step and the second step. A circuit board being is fastened to the lower cover and has LEDs, a switch and two positioning holes. The two positioning holes are separately passed by the two positioning posts.

### BRIEF DESCRIPTION OF THE DRAWINGS

FIGS. 1-3 show a conventional bicycle safety light;

FIG. 4 is an exploded view of the invention;

FIG. 5 is an assembled view of the invention;

FIG. 6 is a cross-sectional view of the invention;

FIG. 7 is a cross-sectional view along line A-A in FIG. 6; and

FIG. 8 is a schematic view of the invention mounted on a fender.

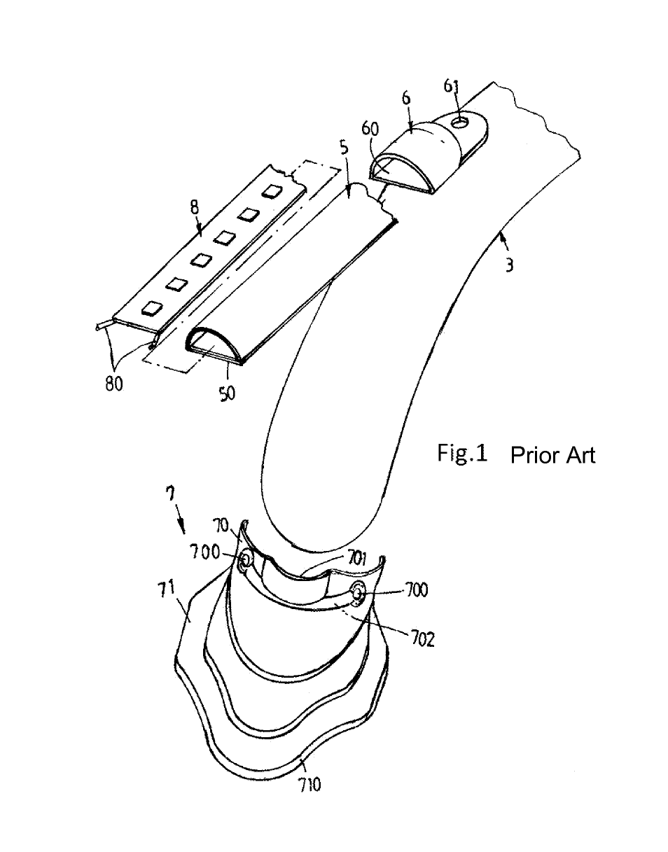

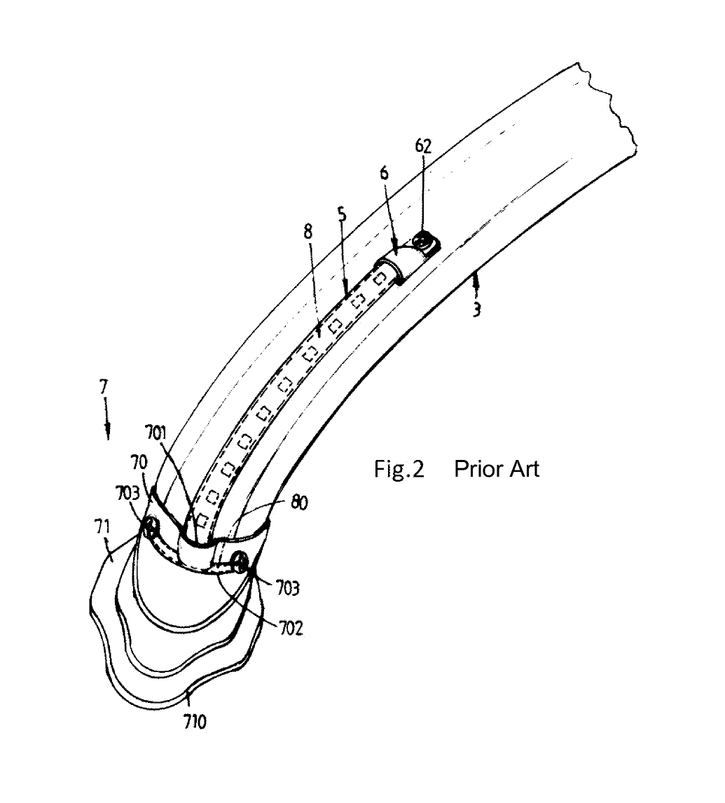

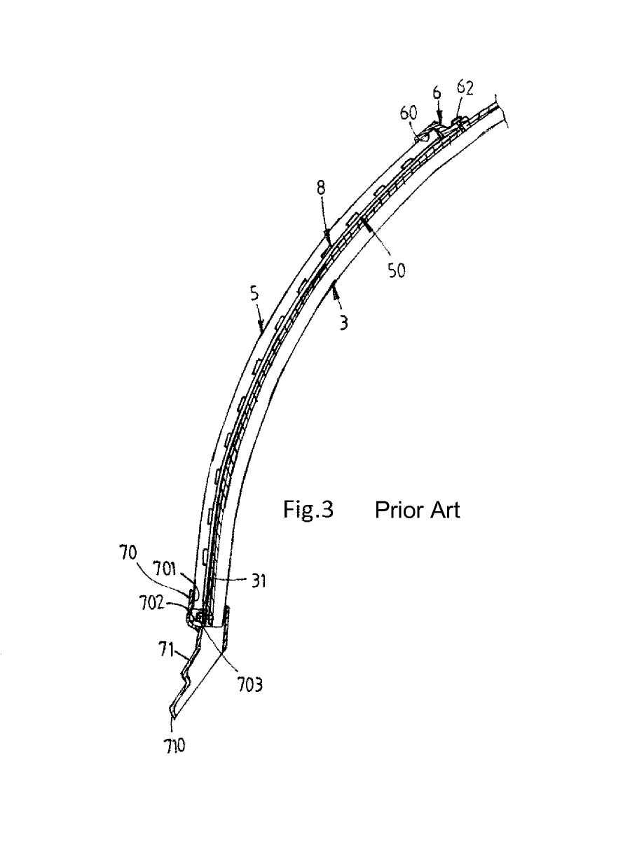

### DETAILED DESCRIPTION OF THE INVENTION

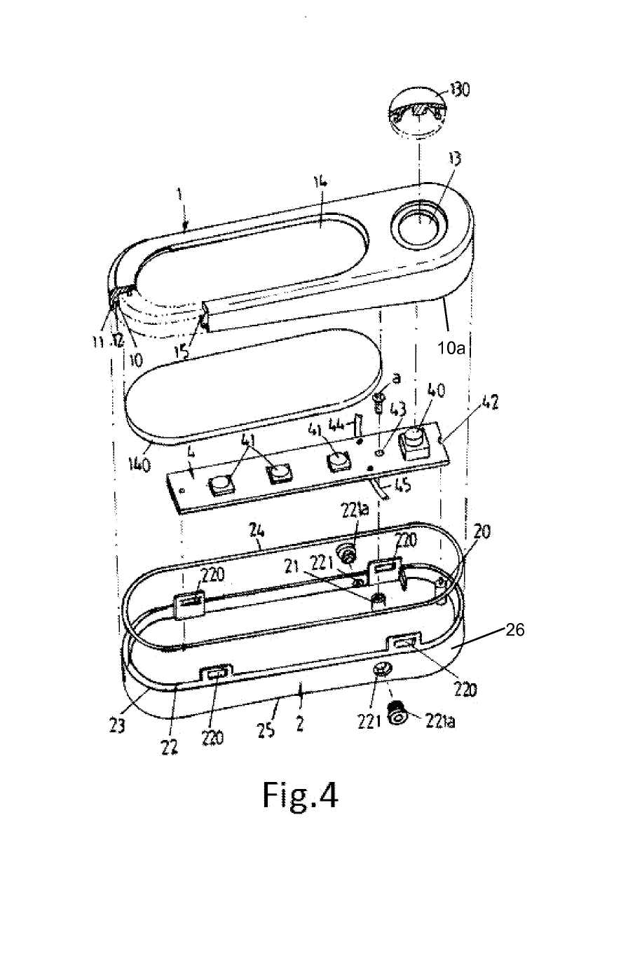

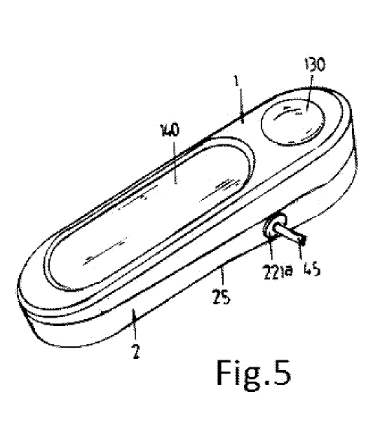

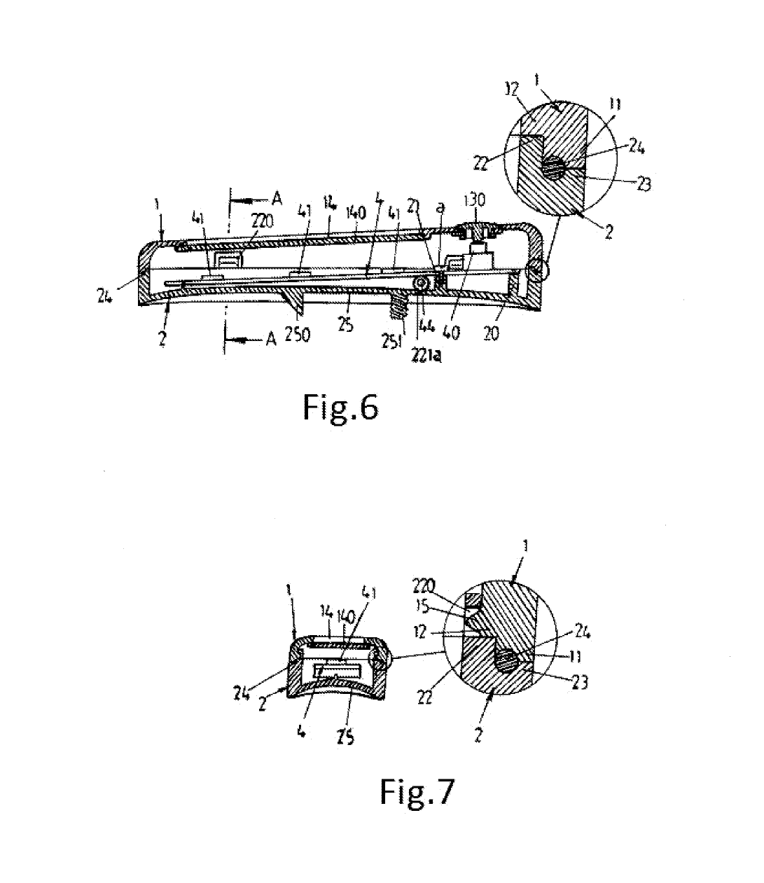

Please refer to FIGS. 4-7. The safety light of the invention includes an upper cover 1, a lower cover 2 and a circuit board 4. The lower cover 2 is similar to a box and has a bottom 25, a surrounding wall 26, two positioning posts 20, 21 erected on the bottom 26. A top of the surrounding wall 26 is formed with a first step. The first step is formed by an inner portion 22 and an outer portion 23 which is shorter than the inner portion 22 in height. Four holed seats 220 extend from the inner portion 22 of the first step. A positioning protrusion 250 and a threaded rod 251 outward extend from the outside of the bottom 25. The outside of the bottom 25 is arcked in longitudinal and transversal directions for matching the shape of a fender 3. The surrounding wall 26 is formed with at least one wire hole 221 with a water-resistant sleeve 221a.

The circuit board 4 has a plurality of light emitting diodes (LEDs) 41, a switch 40 and two positioning holes 42, 43. The circuit board 4 is fastened into the lower cover 2 by a screw a. The two positioning holes 42, 43 are separately passed by the two positioning posts 20, 21. Two wires 44, 45 pass through the water-resistant sleeve 221a to connect a battery.

The upper cover 1 corresponds to the lower cover 2 in shape to assemble therewith. The upper cover 1 has a surrounding edge 10a, a switch hole 13, a lighting hole 14, and a diffuser board 140 secured in the lighting hole 14. A top of the surrounding edge 10a is formed with a second step corresponding to the first step. The second step is formed by an inner portion 10 and an outer portion 11 which is higher than the inner portion 10 in height. Four latches 15 extend from the inner portion 10 of the second step for separately engaging with the four holed seats 220 of the lower cover 2. A groove 12 is formed between the inner portion 10 and the outer portion 11 of the second step. A sealing ring 24 is placed in the groove 12 to be pressed between the first step and the second step for resisting water. The switch hole 13 is provided with a water-resistant plug 130. The upper cover 1 and the lower cover 2 are fixed to each other by engagement of the holed seats 220 and the latches 15.

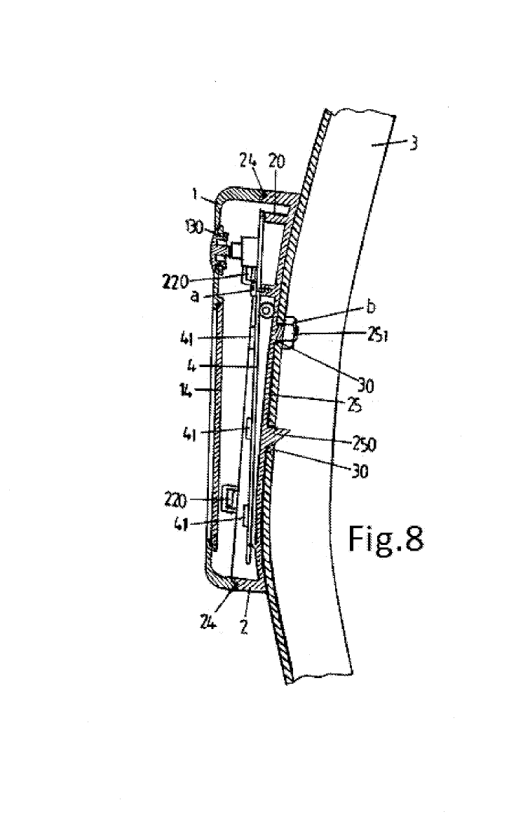

Please refer to FIG. 8. The positioning protrusion 250 and the threaded rod 251 are used to penetrate fixing holes 30 of the fender 3. A nut b is screwed on the threaded rod 251 to fasten the lower cover 2 on the fender 3.

It will be appreciated by persons skilled in the art that the above embodiment has been described by way of example only and not in any limitative sense, and that various alterations and modifications are possible without departure from the scope of the invention as defined by the appended claims.

What is claimed is:

1. A fender-mounted bicycle safety light, comprising:
a lower cover, having a bottom, a surrounding wall, two positioning posts on the bottom, wherein a top of the surrounding wall is formed with a first step, the first step is formed by an inner portion and an outer portion which is shorter than the inner portion in height, four holed seats extend from the inner portion of the first step, a positioning protrusion and a threaded rod outward extend from the bottom, and an outside of the bottom is arcked in longitudinal and transversal directions;
an upper cover, assembled with the lower cover, having a surrounding edge, a lighting hole, and a diffuser board secured in the lighting hole, wherein a top of the surrounding edge is formed with a second step corresponding to the first step, the second step is formed by an inner portion and an outer portion which is higher than the inner portion in height, four latches extend from the inner portion of the second step for separately engaging with the four holed seats of the lower cover, a groove is formed between the inner portion and the outer portion of the second step, and a sealing ring is placed in the groove to be pressed between the first step and the second step; and
a circuit board, having light emitting diodes (LEDs), a switch and two positioning holes, being fastened to the lower cover, wherein the two positioning holes are separately passed by the two positioning posts.

2. The fender-mounted bicycle safety light of claim 1, wherein the surrounding wall is formed with a wire hole with a water-resistant sleeve.

3. The fender-mounted bicycle safety light of claim 1, wherein the upper cover has a switch hole with a water-resistant plug.
